(19) United States
(12) Patent Application Publication
(10) Pub. No.: US 2003/0203244 A1
(43) Pub. Date: Oct. 30, 2003

(54) Magnetic recording medium and method of producing the same

(75) Inventors: Hideki Isono, Tokyo (JP); Hirotaka Tanaka, Tokyo (JP); Teiichiro Umezawa, Tokyo (JP); Tomotaka Yokoyama, Tokyo (JP); Kenji Ayama, Singapore (SG)

Correspondence Address: SUGHRUE MION, PLLC, 2100 PENNSYLVANIA AVENUE, N.W., WASHINGTON, DC, 20037, US

(73) Assignees: HOYA CORPORATION; HOYA MAGNETICS SINGAPORE PTE. LTD.

(21) Appl. No.: 10/422,802

(22) Filed: Apr. 25, 2003

(30) Foreign Application Priority Data
Apr. 25, 2002 (JP) 124500/2002

(51) Int. Cl. G11B 5/66

(52) U.S. Cl. 428/694 SG; 428/694 R

(57) ABSTRACT

In a magnetic recording medium (10) including a glass substrate (1) which has a principal surface and which includes a compressive stress layer (1aa) as a surface layer having the principal surface, and a magnetic layer (4) formed on the principal surface of the glass substrate, compressive stress produced on the principal surface of the glass substrate is equal to 3 kg/mm² or more. The glass substrate has the principal surface provided with a texture (100) for inducing magnetic anisotropy in the magnetic layer. A distance from the principal surface of the glass substrate to the magnetic layer is equal to 1200 angstroms or less.

### BACKGROUND OF THE INVENTION

This invention relates to a magnetic recording medium and, in particular, to a magnetic disk to be mounted to a HDD (Hard Disk Drive) and the like.

Following the rapid development of the IT (Information Technology) industry, dramatic technical innovation is required in the information recording technology, particularly, in the magnetic recording technology. In a magnetic disk mounted to a HDD or the like, a technique capable of achieving an information recording density on the order of 40 to 100 Gbit/inch² is required to meet the demand for a higher recording capacity.

The magnetic disk is required to be excellent in magnetic characteristic particularly in a flying/tracking direction (or a circumferential direction) of a magnetic recording head. In view of the above, Japanese Unexamined Patent Publication No. S62-273619 discloses a technique in which a magnetic layer is formed on a metal substrate, such as an aluminum alloy substrate, after a texture is formed on a surface of the substrate to induce magnetic anisotropy. Thus, magnetic characteristic in the flying/tracking direction of the magnetic recording head is improved as compared with that in a radial direction.

Following the recent demand for mobile use and miniaturization of the HDD, attention is directed to a glass substrate high in rigidity, excellent in shock resistance, and high in surface smoothness. Since the glass substrate is excellent in shock resistance, it is unnecessary to compensate the rigidity by coating the substrate with a metal film such as a NiP film as required in the aluminum alloy substrate. Therefore, a production process of the magnetic disk is shortened and production cost is reduced. In addition, the magnetic disk is easily reduced in size.

For example, in Japanese Unexamined Patent Publication No. 2002-32909, the present inventors have disclosed a magnetic recording medium comprising a glass substrate provided with a circumferential texture formed thereon, and a magnetic layer formed on the glass substrate by sputtering.

In case of the glass substrate also, it is desired that magnetic characteristic in a circumferential direction (a flying/tracking direction) is superior to that in a radial direction.

For example, in order to achieve a recording density of 40 Gbit/inch² or more, an oriented ratio of magnetic anisotropy (MrtOR) in terms of a product of residual magnetization and film thickness must be equal to 1.2 or more. In order to achieve a recording density of 50 Gbit/inch² or more, MrtOR must be equal to 1.3 or more. For a higher recording density of 60 Gbit/inch² or more, MrtOR is desirably equal to 1.35 or more.

The above-mentioned MrtOR represents the oriented ratio OR of magnetic anisotropy calculated from the product (Mrt) of residual magnetization and film thickness. At any given point on a principal surface of the magnetic recording medium, the product of residual magnetization and film thickness in the circumferential direction is represented by Mrt(c) while the product of magnetization and film thickness in the radial direction is represented by Mrt(r). MrtOR is defined as Mrt(c)/Mrt(r) as a ratio of Mrt(c) with respect to Mrt(r).

Herein, Mrt is a product of Mr (residual magnetization) and t (thickness of the magnetic layer of the medium).

If MrtOR is substantially equal to 1, the magnetic recording medium has a magnetic isotropy such that the magnetic characteristic in the circumferential direction is substantially same as that in the radial direction.

As MrtOR becomes greater beyond 1, the magnetic anisotropy in the circumferential direction is improved.

In case where the texture is formed on a metallic surface of, for example, the aluminum alloy substrate or a substrate coated with a metal film such as a NiP film, the magnetic anisotropy is improved. On the other hand, in case where the texture is directly formed on a surface of the glass substrate, MrtOR is no more than 1.0 to 1.1 although the reason is not yet revealed. This constitutes a factor of inhibiting an increase in capacity and a decrease in production cost of the HDD.

### SUMMARY OF THE INVENTION

It is therefore an object of this invention to provide a magnetic recording medium which is capable of obtaining MrtOR of 1.2 or more so as to achieve a recording density of 40 Gbit/inch² or more even if a glass substrate is used and which is excellent in shock resistance and low in production cost.

This invention has following structures.

A magnetic recording medium comprising: a glass substrate which has a principal surface and which includes a compressive stress layer as a surface layer having the principal surface; and a magnetic layer formed on the principal surface of the glass substrate; wherein:

compressive stress produced on the principal surface of the glass substrate is equal to 3 kg/mm² or more;

the glass substrate having the principal surface provided with a texture for inducing magnetic anisotropy in the magnetic layer;

a distance from the principal surface of the glass substrate to the magnetic layer being equal to 1200 angstroms or less.

Structure 2

A magnetic recording medium as described in Structure 1, wherein a nonmagnetic layer interposed between the principal surface of the glass substrate and the magnetic layer has a thickness not greater than 1200 angstroms.

Structure 3

A magnetic recording medium as described in Structure 1 or 2, wherein the compressive stress layer has a thickness not smaller than 5 μm.

Structure 4

A magnetic recording medium as described in any one of Structures 1 through 3, wherein an oriented ratio of magnetic anisotropy in terms of a product of residual magnetization and film thickness is not smaller than 1.2 in the magnetic recording medium.

Structure 5

A magnetic recording medium as described in any one of Structures 1 through 4, wherein:

the compressive stress layer is formed by ion exchange.

Structure 6

A magnetic recording medium as described in any one of Structures 1 through 5, wherein:

the magnetic layer has a hcp crystal structure.

Structure 7

A magnetic recording medium comprising: a glass substrate which has a principal surface and which includes a compressive stress layer as a surface layer having the principal surface; and a magnetic layer formed on the principal surface of the the glass substrate; wherein:

the glass substrate has the principal surface provided with a texture for inducing magnetic anisotropy in the magnetic layer;

an oriented ratio of magnetic anisotropy in terms of a product of residual magnetization and film thickness being equal to 1.2 or more in the magnetic recording medium.

Structure 8

A method of producing a magnetic recording medium having magnetic anisotropy, in which a nonmagnetic layer and a magnetic layer are formed on a principal surface of a glass substrate having a compressive stress layer as a surface layer and a texture formed on the principal surface of the glass substrate to induce magnetic anisotropy in the magnetic layer, the method comprising the steps of:

preliminarily obtaining correlation between an oriented ratio of magnetic anisotropy and each of a compressive stress value on the principal surface of the glass substrate and a thickness of the nonmagnetic layer;

selecting the compressive stress value and the thickness of the nonmagnetic layer as selected conditions with reference to the correlation so as to obtain a predetermined oriented ratio; and

forming the compressive stress layer of the glass substrate and the nonmagnetic layer in accordance with the selected conditions.

As a result of inventors' studies upon the above-mentioned objects, it has been found out that, in case where the texture for inducing the magnetic anisotropy is directly formed on the glass substrate, the oriented ratio of magnetic anisotropy (MrtOR) can be increased to 1.2 or more by forming the compressive stress layer as the surface layer of the glass substrate and accurately designing the compressive stress value on the surface of the glass substrate and the distance from the surface of the substrate to the magnetic layer. Herein, the oriented ratio of magnetic anisotropy (MrtOR) is defined as a ratio of Mrt in the flying/tracking direction of a magnetic recording head (or circumferential direction of the magnetic recording medium) with respect to Mrt in the radial direction.

Specifically, it has been found out that the magnetic anisotropy in terms of MrtOR of 1.2 or more can be obtained by producing the compressive stress on the surface of the glass substrate, adjusting the value of the compressive stress to 3 kg/mm² or more, and adjusting the distance from the surface of the substrate to the magnetic layer to 1200 angstroms or less.

Although the above-mentioned mechanism is not clarified in detail, it is believed that, if magnetic grains are deposited on the surface of the substrate applied with the compressive stress, the compressive stress are transmitted to the magnetic grains deposited on the surface.

In accordance with the magnetic physics, the magnetic anisotropy of a magnetic material mainly originates from an easy magnetization axis by crystal anisotropy. For example, in case where the magnetic layer is made of a material including a Co alloy, a c-axis of the hcp crystal structure serves as the easy magnetization axis by the crystal anisotropy. Therefore, the magnetic anisotropy is exhibited along the c-axis.

However, it is known that, if the crystal structure is given distortion by an external force, the crystal anisotropy is changed. This phenomenon is described as magnetostriction by the Villari effect.

In this invention, the substrate is provided with the texture for inducing the magnetic anisotropy. With this structure, the magnetic grains are arranged in the flying/tracking direction of the magnetic recording head. In addition, high compressive stress is produced on the surface of the substrate to apply the compressive stress upon the magnetic grains deposited thereon. Under the Vllari effect, high magnetic anisotropy is exhibited.

Accordingly, as the compressive stress produced on the substrate surface is greater, the compressive stress applied upon the magnetic grains is increased.

The compressive stress transmitted to the magnetic grains is decreased in proportion to the distance between the surface of the substrate and the magnetic layer. Therefore, the distance between the surface of the substrate and the magnetic layer is preferably as small as possible.

Based on the above-mentioned findings, the present inventors studied upon the compressive stress on the glass substrate provided with the texture for inducing the magnetic anisotropy and the distance between the surface of the substrate and the magnetic layer. As a result, it has been found out that, in order to achieve MrtOR of 1.2 or more, the compressive stress on the glass substrate must be equal to 3 kg/mm² or more and the distance from the surface of the glass substrate to the magnetic layer is equal to 1200 angstroms or less.

Herein, the distance between the surface of the substrate and the magnetic layer is a distance between the principal surface of the substrate and a surface of the magnetic layer which is faced to the principal surface of the substrate and which is closest to the principal surface of the substrate.

It is preferable that the magnetic layer is directly formed on the substrate because the compressive stress directly acts upon the magnetic layer. Practically, however, a nonmagnetic layer is often interposed between the surface of the substrate and the magnetic layer in order to adjust the size of the magnetic grains and to suppress the variation in size of the magnetic grains. In case where the nonmagnetic layer is interposed, the thickness of the nonmagnetic layer is selected to be equal to or smaller than 1200 angstroms so that the distance between the surface of the substrate and the magnetic layer is equal to or smaller than 1200 angstroms.

In order to further improve the effect of this invention and to obtain MrtOR of 1.3 or more, it is desired that the compressive stress on the surface of the glass substrate is equal to or greater than 8 kg/mm² or that the distance from the surface of the glass substrate to the magnetic layer is equal to or smaller than 1000 angstroms. Furthermore, in order to achieve MrtOR of 1.35 or more, it is desired that the compressive stress is equal to or greater than 12 kg/mm² or that the distance from the surface of the glass substrate to the magnetic layer is equal to or smaller than 800 angstroms.

The compressive stress of 20 kg/mm² or more is not preferable from a practical standpoint because the stress is excessive and the glass substrate may be broken. Consideration will be made of the distance between the glass substrate and the magnetic layer. For example, in case where the nonmagnetic layer and any additional layer are interposed between the glass substrate and the magnetic layer and if the distance between the surface of the glass substrate and the magnetic layer is smaller than 200 angstroms, these layers interposed are degraded in function so that the size of the magnetic grains is not adjusted and the variation in size is increased. This brings about an increase in medium noise and a decrease in S/N ratio and, consequently, may inhibit the achievement of a high recording density. From the above, it is desired from a practical standpoint that the total thickness of the layers interposed between the surface of the glass substrate and the magnetic layer is not smaller than 200 angstroms.

In this invention, the compressive stress layer formed as the surface layer of the glass substrate preferably has a thickness not smaller than 5 μm. If the thickness is smaller than 5 μm, the difference in compressive stress tends to occur between a deepest point of the texture and the surface of the glass substrate to cause microscopic variation in MrtOR on the surface of the magnetic layer. In addition, the shock resistance is lowered. Therefore, the thickness smaller than 5 μm is unfavorable as a HDD for mobile applications or a HDD of a LUL (Load UnLoad) system. On the other hand, if the compressive stress layer has a thickness not smaller than 5 μm, variation in MrtOR can sufficiently be suppressed and the shock resistance is improved. Therefore, the thickness not smaller than 5 μm is useful as the HDD for mobile applications or the HDD of the LUL system. In particular, the thickness of 10 μm or more is advantageous.

If the thickness of the compressive stress layer is excessively large, the compressive stress value on the surface of the substrate may be decreased due to stress relaxation. Therefore, in a practical standpoint, the thickness is preferably selected within a range such that the effect of this invention is not lessened. In case of a thin-profile disk having a thickness of 0.9 mm or less, the decrease in compressive stress on the surface of the substrate can be suppressed if the compressive stress layer has a thickness of 150 μm or less.

The texture for inducing the magnetic anisotropy is required to have a regular shape such that the magnetic anisotropy in the flying/tracking direction of the magnetic recording head is improved. In case of a magnetic disk, the tracking direction of the magnetic recording head is a circumferential direction. Therefore, use may be made of a circumferential texture having circular components regularly arranged, a cross texture having shape components intersecting therewith, an elliptical texture, a spiral texture, or a combination of these shape components. Among others, the circumferential texture is preferable because of an excellent effect of orienting the magnetic grains in the tracking direction of the magnetic recording head.

As described above, the oriented ratio of magnetic anisotropy (MrtOR) is preferably as high as possible. However, if the oriented ratio of magnetic anisotropy exceeds 3, Mrt in the radial direction (Mrt(r)) with respect to Mrt in the flying/tracking direction (Mrt(c)) of the magnetic head becomes smaller than ⅓. This may result in an increase in medium noise on the side of a recording track, making it difficult to improve TPI (Tracks Per Inch). Practically, MrtOR is advantageously equal to or smaller than 3.

In this invention, the compressive stress layer as the surface layer of the glass substrate is preferably formed by ion exchange. Preferably, ion exchange is carried out by chemical strengthening. The compressive stress layer formed by the chemical strengthening is preferable because high compressive stress of 3 kg/mm² or more, furthermore 8 kg/mm² or more can be produced on the surface of the glass substrate by selecting chemically strengthening conditions (the type and the composition of a chemically strengthening salt, the chemically strengthening temperature, the chemical strengthening time, and so on). Furthermore, the compressive stress on the surface of the substrate is rendered uniform in an in-plane direction. In addition, the compressive stress layer formed by the chemical strengthening is preferable because the thickness of 5 μm or more, or 10 μm or more can be achieved. In view of production, the compressive stress value and the thickness of the compressive stress layer can be designed with a high degree of freedom by appropriately selecting the chemically strengthening conditions.

In this invention, the composition of the magnetic layer is not specifically limited. However, a material made of a Co alloy having a hcp crystal structure is preferable because the crystal anisotropy is high. In particular, a CoPt alloy is preferable because high coercive force of 3000 oersted or more can be obtained. A CoCr alloy is preferable because exchange interaction between the magnetic grains can be suppressed by Cr so that the medium noise can be reduced. Besides the CoPt alloy and the CoCr alloy mentioned above, a CoCrPt alloy, a CoCrPtTa alloy, a CoCrPtTaB alloy, a CoCrPtB alloy, a CoCrPtNb alloy may be used as the Co alloy. Among others, the CoCrPtB alloy is low in medium noise and is therefore advantageous in order to achieve a high recording density. In case of the CoCrPtB alloy, a preferable composition is 13-25 at % Co, 6-15 at % Pt, 2-10 at % B, and the balance Co.

In this invention, one magnetic layer or a plurality of magnetic layers may be formed. In case where a plurality of magnetic layers are formed, a nonmagnetic alloy material, a paramagnetic alloy material, an antiferromagnetic alloy material, a ferrimagnetic alloy material, a helimagnetic alloy material, or the like may be interposed between the magnetic layers to miniaturize the magnetic grains or to exert magnetic interaction between the magnetic layers. All or a part of the magnetic layers may be bonded.

In case where a plurality of magnetic layers are formed, the distance between at least one of the magnetic layers which is closest to the principal surface of the substrate is preferably not greater than 1200 angstroms. More preferably, the distance from the principal surface of the glass substrate is not greater than 1200 angstroms for all of the magnetic layers.

According to this invention, there is also provided a method of producing a magnetic recording medium having magnetic anisotropy, in which a nonmagnetic layer and a magnetic layer are formed on a glass substrate having a compressive stress layer as a surface layer and a texture formed on a surface of the glass substrate to induce magnetic anisotropy in the magnetic layer, the method comprising the steps of:

preliminarily obtaining correlation between an oriented ratio of magnetic anisotropy and each of a compressive stress value on the surface of the glass substrate and a thickness of the nonmagnetic layer;

selecting the compressive stress value and the thickness of the nonmagnetic layer as selected conditions with reference to the correlation so as to obtain a predetermined oriented ratio; and

forming the compressive stress layer of the glass substrate and the nonmagnetic layer in accordance with the selected conditions.

By designing the magnetic recording medium in the above-mentioned manner, a desired oriented ratio of magnetic anisotropy (MrtOR) in terms of the product of residual magnetization and film thickness can be obtained with excellent reproducibility. Therefore, even if a large amount of magnetic recording media are mass produced, it is possible to suppress the variation in MrtOR of the magnetic recording media and to improve the production yield. As a consequence, it is possible to reduce the production cost and the price of the magnetic recording media.

In this invention, the chemical strengthening can be carried out by any known chemical strengthening techniques without any specific limitation. The glass substrate can be chemically strengthened by dipping the glass substrate in a chemically strengthening salt heated and melted and replacing ions in the surface layer of the glass substrate by ions in the chemically strengthening salt by ion exchange.

As an ion exchanging method, use may be made of low-temperature ion exchange, high-temperature ion exchange, surface crystallization, and so on. In view of a glass transition point, it is preferable to use the low-temperature ion exchange in which ion exchange is carried out in a temperature range not higher than the glass transition point. The low-temperature ion exchange is a method in which alkali ions in a glass are replaced by alkali ions greater in ion radius in a temperature range not higher than the transition point (Tg) of the glass so that an ion-exchanged part is increased in volume to thereby produce high compressive stress in a surface layer of the glass.

As the chemically strengthening salt, use may be made of a molten salt of potassium nitrate, sodium nitrate, potassium carbonate, or the like, a molten salt of a mixture of these salts, and a molten salt of a mixture of any of the above-mentioned salt and an ionic salt of Cu, Ag, Rb, Cs, or the like. Instead of the molten salt, use may be made of a solution of the above-mentioned salt as a chemically strengthening solution. The chemically strengthening solution is preferably heated to a temperature between 280° C. and 660° C., more preferably between 300° C. and 400° C. in view of ion exchange. The dipping time preferably falls within a range between 10 minutes and 10 hours. Preferably, the glass substrate is preheated to a temperature between 100° C. and 300° C. before the glass substrate is dipped into the molten salt. The glass substrate after chemically strengthened is processed into a product through cooling and washing steps. The glass substrate is not particularly restricted as far as it can be chemically strengthened. The diameter of the glass substrate is not particularly restricted in view of the effect of this invention. For a small-sized magnetic disk having a diameter of 2.5 inches or less, which is often used as a HDD for mobile applications, this invention is very useful and advantageous because the magnetic disk having high shock resistance and an information recording density as high as 40 Gbit/inch² and low in price can be provided.

Preferably, the glass substrate has a thickness between 0.1 mm and 1.5 mm. In particular, for a magnetic disk comprising a thin substrate having a thickness between 0.1 mm and 0.9 mm, this invention is very useful and advantageous because the magnetic disk having high shock resistance and an information recording density as high as 40 Gbit/inch² and low in price can be provided.

As a material of the glass substrate, use may be made of an aluminosilicate glass, a soda lime glass, a soda aluminisilicate glass, an aluminoborosilicate glass, a borosilicate glass, a silica glass, a chain silicate glass, or glass ceramics such as a crystallized glass. The aluminosilicate glass is particularly preferable because shock resistance and vibration resistance are excellent.

As the aluminosilicate glass, use is preferably made of a chemically strengthenable glass essentially consisting of 62-75 wt % SiO₂, 5-15 wt % Al₂O₃, 4-10 wt % Li₂O, 4-12 wt % Na₂O, and 5.5-15 wt % ZrO₂ with Na₂O/ZrO₂ of 0.5-2.0 in weight ratio and Al₂O₃/ZrO₂ of 0.4-2.5 in weight ratio. In order to prevent a protrusion from being formed on the surface of the glass substrate because of presence of an undissolved portion of ZrO₂, use is preferably made of a chemically strengthenable glass essentially consisting of 57-74% SiO₂, 0-2.8% ZrO₂, 3-15%Al₂O₃, 7-16% Li₂O, and 4-12% Na₂O in mol %.

By chemically strengthening the above-mentioned aluminosilicate glass, the glass is improved in fracture strength, rigidity, shock resistance, vibration resistance, and heat resistance, is prevented from precipitation of Na even under a high-temperature environment, maintains a flatness, and is excellent in Knoop hardness.

In this invention, a nonmagnetic layer or layers, such as a seed layer, an underlying layer, and an onset layer may be interposed between the glass substrate and the magnetic layer. In this case, the total thickness of the nonmagnetic layers is selected to be not greater than 1200 angstroms so that the distance between the surface of the glass substrate and the magnetic layer is not greater than 1200 angstroms.

For example, the seed layer is formed by an alloy having a bcc crystal structure or a B2 crystal structure, such as an Al alloy, a Cr alloy, an NiAl alloy, an NiAlB alloy, an AlRu alloy, an AlRuB alloy, an AlCo alloy, and an FeAl alloy, so that the magnetic grains can be miniaturized. Among others, the AlRu alloy, particularly, consisting of 30-70 at % Al and the balance Ru is preferable because of an excellent effect of miniaturizing the magnetic grains.

The underlying layer may be formed by a Cr alloy, a CrMo alloy, a CrV alloy, a CrW alloy, a CrTi alloy, or a Ti alloy to serve as a layer for adjusting the orientation of the magnetic layer. Among others, the CrW alloy, particularly, consisting of 5-40 at % W and the balance Cr is preferable because of an excellent effect of adjusting the orientation of the magnetic grains.

The onset layer may be made of a nonmagnetic material having a crystal structure similar to that of the magnetic layer so as to help epitaxial growth of the magnetic layer. For example, if the magnetic layer is made of a Co alloy material, the onset layer is made of a nonmagnetic material having a hcp crystal structure, for example, a CoCr alloy, a CoCrPt alloy, and a CoCrPtTa alloy.

It is noted here that the Co alloy material may exhibit a ferromagnetic phase in accordance with a Slater-Polling curve in the magnetic physics, depending upon the composition ratio of elements other than Co. Therefore, it is necessary to adjust the composition ratio so as to exhibit a nonmagnetic phase.

In this invention, a protection layer may be formed on the magnetic layer. For example, the protection layer may comprise a carbon protection film, a hydrogenated carbon protection film, a nitrogenated carbon protection film, a hydrogenated nitrogenated carbon protection film, a silica protection film, a zirconia protection film, and a hafnia protection film.

In this invention, a lubrication layer may be formed on the protection layer. A lubricant forming the lubrication layer may be a PFPE (perfluoropolyether) compound or a compound obtained by introducing a functional group such as a polar group into an end group of PFPE.

In this invention, film deposition on the glass substrate can be carried out by the use of a known technique. Among others, sputtering is advantageous because each layer can be reduced in thickness. For deposition of a carbon-based protection film, P-CVD (Plasma Chemical Vapor Deposition) or IBD (ion Beam Deposition) is advantageous because protectability is improved. The lubrication layer may be formed by preparing a solution obtained by dissolving a lubricant in a solvent and applying the solution using dipping, spraying, spin coating, or vapor deposition.

The magnetic recording medium according to this invention is highly useful for use with a magnetic head having a magnetoresistance (MR) read element. The MR read element is highly sensitive to a recorded signal and produces a readout signal having a high output level. Therefore, the MR read element is suitable for use with a magnetic disk having an information recording density of 40 Gbit/inch² or more. The MR read element may be an AMR (anisotropic magnetoresistance) element, a GMR (giant magnetoresistance) element, and a TMR (tunneling magnetoresistance) element.

As a HDD to which the magnetic disk according to this invention is mounted, a small-sized disk of a 2.5 inch type or a smaller type is preferable as described in the foregoing. Preferably, a start-stop system of the HDD is a LUL (Load Unload) system. In the LUL system, a wide recording area of the magnetic disk can be assured so that a high recording capacity is achieved. In addition, shock resistance is excellent so that the LUL system is suitable for mobile applications.

In this invention, Mrt(c) and Mrt(r) can appropriately be selected. Preferably, however, each of Mrt(c) and Mrt(r) is not greater than 0.5 memu/cc. If the value exceeds 0.5 memu/cc, medium noise is increased so that the magnetic recording medium is inappropriate for use with the MR read element.

### BRIEF DESCRIPTION OF THE DRAWINGS

FIG. 1 is a sectional view of a magnetic recording medium according to an embodiment of this invention;

FIG. 2 is a view showing correlation between MrtOR and a compressive stress value;

FIG. 3 is a view showing correlation between MrtOR and a distance from a surface of a substrate to a magnetic layer (total thickness of nonmagnetic layers); and

FIG. 4 is a view for describing a result of analyzing the compressive stress value and a thickness of a compressive stress layer in a magnetic recording medium in Example 1.

### DESCRIPTION OF PREFERRED EMBODIMENTS

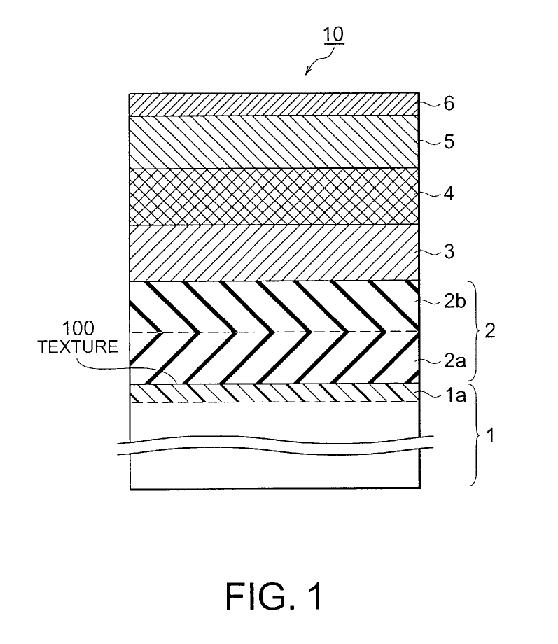

Referring to FIG. 1, a magnetic recording medium 10 according to an embodiment of this invention comprises a glass substrate 1. The glass substrate 1 comprises an aluminosilicate glass chemically strengthened, polished, and provided with a texture 100 of, for example, a circular texture. More specifically, the texture 100 is formed on a principal surface of the glass substrate 1. The glass substrate 1 has, as a surface layer, a compressive stress layer 1a obtained by chemical strengthening. On the glass substrate 1, a seed layer 2, an underlying layer 3, a magnetic layer 4, a protection layer 5, and a lubrication layer 6 are successively deposited and laminated in this order.

The seed layer 2 comprises a first seed layer 2a and a second seed layer 2b. Each of the seed layer 2 and the underlying layer 3 is a nonmagnetic layer.

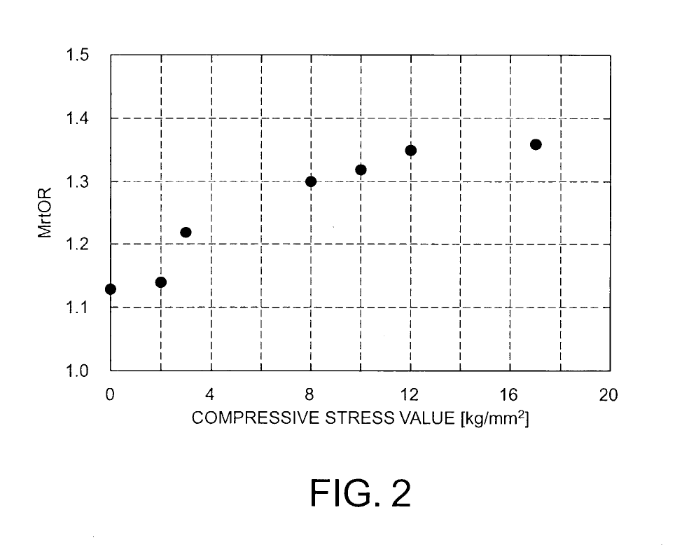

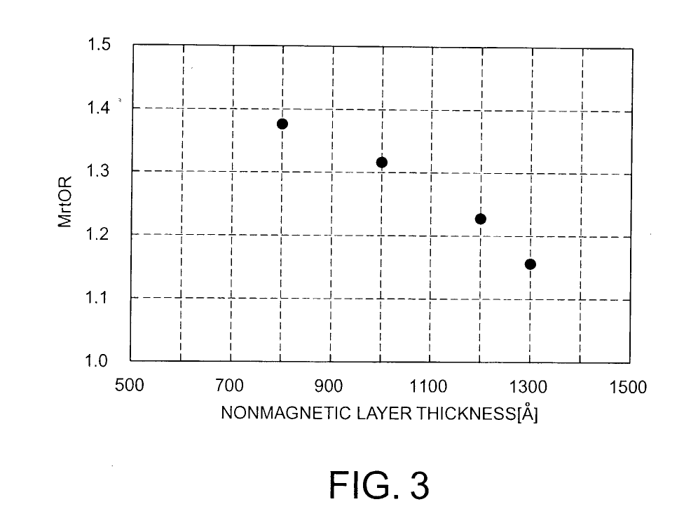

In order to investigate correlation between MrtOR and each of a compressive stress value on a surface of the substrate and a total thickness of the nonmagnetic layers (a distance from the surface of the substrate to the magnetic layer), the present inventors prepared a plurality of samples different in compressive stress value and in total thickness of the nonmagnetic layers and carried out experimental tests. The result of the experimental tests are shown in FIGS. 2 and 3. The measurement was made in the manner similar to that described later.

FIG. 2 shows the correlation between MrtOR and the compressive stress value on the surface of the glass substrate. In each of the samples used herein, the seed layer 2 includes the first seed layer 2a comprising a Cr alloy thin film (having a thickness of 600 angstroms) and the second seed layer 2b comprising an AlRu thin film (having a thickness of 300 angstroms). The AlRu thin film has a composition of 50 at % Al and 50 at % Ru.

The underlying layer 3 comprises a CrW thin film (having a thickness of 100 angstroms) which has a composition of 90 at % Cr and 10 at % W. The magnetic layer 4 comprises a CoCrPtB alloy and has a thickness of 150 angstroms. The magnetic layer 4 has a composition of 62 at % Co, 20 at % Cr, 12 at % Pt, and 6 at % B. As described above, the first seed layer 2a, the second seed layer 2b, and the underlying layer 3 have thicknesses of 600 angstroms, 300 angstroms, and 100 angstroms, respectively. Therefore, the total thickness of the nonmagnetic layers (i.e., the distance from the glass substrate to the magnetic layer) in each of the samples of FIG. 2 is equal to 1000 angstroms.

From FIG. 2, it has been found out that the correlation exists between MrtOR and the compressive stress value on the surface of the glass substrate.

Next, in order to investigate the correlation between MrtOR and the total thickness of the nonmagnetic layers, preparation was made of a plurality of samples in which the compressive stress value on the surface of the glass substrate 1 is equal to 10 kg/mm² but the total thickness of the nonmagnetic layers is different. The results are shown in FIG. 3. From FIG. 3, it has been found out that the correlation exists between MrtOR and the total thickness of the nonmagnetic layers.

Next, with reference to the correlations obtained in FIGS. 2 and 3, the compressive stress value on the surface of the glass substrate and the total thickness of the nonmagnetic layers are selected as selected conditions so that MrtOR has a predetermined value. Under the selected conditions, magnetic recording media were produced in Examples and Comparative Examples.

### EXAMPLE 1

In Example 1, the compressive stress value and the total thickness of the nonmagnetic layers were selected to be equal to 10 kg/mm² and 800 angstroms, respectively, as selected conditions so that MrtOR has a value of 1.38. Under the selected conditions, the magnetic recording medium was produced.

The magnetic recording medium in Example 1 was produced by a method including (1) a rough lapping step (rough grinding step), (2) a shaping step, (3) a fine lapping step (fine grinding step), (4) an end-face mirror-polishing step, (5) a first polishing step, (6) a second polishing step, (7) a chemically strengthening step, (8) a texturing step, and (9) a magnetic disk producing step.

(1) Rough Lapping Step

At first, a molten glass was subjected to direct pressing by the use of an upper mold, a lower mold, and a body mold to obtain a disk-shaped glass substrate made of an aluminosilicate glass and having a diameter of 66 mm φ and a thickness of 1.5 mm. Instead of the direct pressing, the disk-shaped glass substrate may be obtained by forming a sheet glass by a down drawing method or a floating method and then cutting the sheet glass by a grindstone. As the aluminosilicate glass, use was made of a chemically-strengthenable substrate glass essentially consisting of 58-75 wt % SiO₂, 5-23 wt % Al₂O₃, 3-10 wt % Li₂O, and 4-13 wt % Na₂O.

Subsequently, the glass substrate was subjected to a lapping step. The lapping step was carried out by the use of a double-sided lapping apparatus with abrasive grains having a grain size of #400. More specifically, the lapping step was carried out by the use of alumina abrasive grains having a grain size of #400 and by rotating a sun gear and an internal gear under the load of about 100 kg. Thus, opposite surfaces of the glass substrate received in a carrier were lapped to a surface accuracy of 0-1 μm and a surface roughness of about 6 μm in Rmax.

(2) Shaping Step

Next, by the use of a cylindrical grindstone, the glass substrate was bored at its center. In addition, an outer peripheral end face of the glass substrate was ground so that the diameter of the glass substrate is equal to 65 mm φ. Thereafter, the glass substrate was chamfered at its outer and inner peripheral end faces. At this time, the inner and the outer peripheral end faces of the glass substrate had a surface roughness of about 4 μm in Rmax.

Generally, a magnetic disk having an outer diameter of 65 mm is used in a 2.5-inch HDD (Hard Disk Drive).

(3) Fine Lapping Step

Next, by the use of abrasive grains having a grain size of #1000, the surfaces of the glass substrate were lapped to the surface roughness of about 2 μm in Rmax and about 0.2 μm in Ra. After the fine lapping step, the glass substrate was subjected to ultrasonic cleaning by successively immersing the glass substrate in cleaning tanks respectively filled with a neutral detergent and water and applied with ultrasonic waves.

(4) End-face Mirror-Polishing Step

Subsequently, the glass substrate was rotated and the inner and the outer peripheral end faces of the glass substrate were polished by brushing to the surface roughness of about 1 μm in Rmax and about 0.3 μm in Ra. After the end-face mirror-polishing step, the surfaces of the glass substrate were cleaned with water.

(5) First Polishing Step

Next, in order to remove a flaw and a distortion remaining after the above-mentioned lapping step, a first polishing step was carried out by the use of a double-sided polishing apparatus. Operation of the double-sided polishing apparatus is as follows. The glass substrate is held by a carrier and interposed between upper and lower surface tables in contact therewith. Each of the upper and the lower surface tables is provided with a polishing pad attached thereto. The carrier is engaged with a sun gear and an internal gear. The glass substrate is clamped and pressed by the upper and the lower surface tables. Thereafter, a polishing liquid is supplied between each of the polishing pads and each of polished surfaces of the glass substrate while the carrier is rotated. Thus, the glass substrate is rotated and revolved on the surface tables so that the opposite surfaces are simultaneously polished. Hereinafter, the same double-sided polishing apparatus was used in common to all Examples. More specifically, the polishing step was carried out by the use of a hard polisher (hard urethane foam). The polishing condition was as follows.

Abrasive Liquid: cerium oxide (average grain size: 1.3 μm)

Load: 100 g/cm²

Polishing Time: 15 minutes

After the first polishing step, the glass substrate was successively dipped into cleaning tanks respectively filled with a neutral detergent, pure water, pure water, IPA (isopropyl alcohol), and IPA (vapor dry) to be subjected to ultrasonic cleaning and dried.

(6) Second Polishing Step

Next, by the use of a double-sided polishing apparatus of the type same as that used in the first polishing step, the second polishing step was carried out by the use of a soft polisher (suede pad). The second polishing step was intended to reduce the surface roughness, for example, to 1.0-0.3 μm in Ra while maintaining a flat surface obtained in the first polishing step. The polishing condition was as follows.

Abrasive Liquid: cerium oxide (average grain size: 0.8 μm)

Load: 100 g/cm²

Polishing Time: 5 minutes

After the second polishing step, the glass substrate was successively dipped into cleaning tanks respectively filled with a neutral detergent, pure water, pure water, IPA (isopropyl alcohol), and IPA (vapor dry) to be subjected to ultrasonic cleaning and dried.

(7) Chemically Strengthening Step

Next, in order to achieve a predetermined compressive stress value on the surface of the glass substrate, the glass substrate after cleaned was subjected to a chemically strengthening step by low-temperature ion exchange in the following manner.

Specifically, a chemically strengthening molten salt was prepared by mixing potassium nitrate (60%) and sodium nitrate (40%). The chemically strengthening molten salt was heated to 340° C. The glass substrate after cleaned and dried was dipped into the chemically strengthening molten salt for 40 minutes. Thus, the glass substrate was chemically strengthened. After chemically strengthened, the glass substrate was successively dipped into cleaning tanks respectively filled with a neutral detergent, pure water, pure water, IPA (isopropyl alcohol), and IPA (vapor dry) to be subjected to ultrasonic cleaning and dried.

After cleaned, the glass substrate was subjected to visual inspection of its surface and close inspection utilizing reflection, scattering, and transmission of light.

As a result, any protrusion by deposited substances or any defect such as a flaw was not found on the surface of the glass substrate.

Furthermore, the surface roughness of a principal surface of the glass substrate obtained via the above-mentioned steps was measured by an atomic force microscope (AFM). As a result, Rmax and Ra were equal to 2.13 nm and 0.20 nm, respectively. Thus, the glass substrate for a magnetic disk having a ultrasmooth surface was obtained.

The glass substrate had an outer diameter of 65 mm, an inner diameter of 20 mm, and a thickness of 0.635 mm.

(8) Texturing Step

By the use of a tape-type texturing apparatus, the substrate was polished and subjected to circumferential texturing. As a tape, a textile tape was used. As a hard polisher, use was made of a slurry comprising polycrystalline diamond having an average grain size of 0.125 μm and suspended in a dispersing agent.

The working condition of the texturing apparatus was as follows:

Working Load: 1.4 kg

Working Pressure: 12 g/mm²

Rotation Speed of Substrate: 1000 rpm

Tape Feeding Rate: 2 mm/sec

Working Time: 30 sec

Thereafter, the glass substrate was subjected to ultrasonic cleaning and dried.

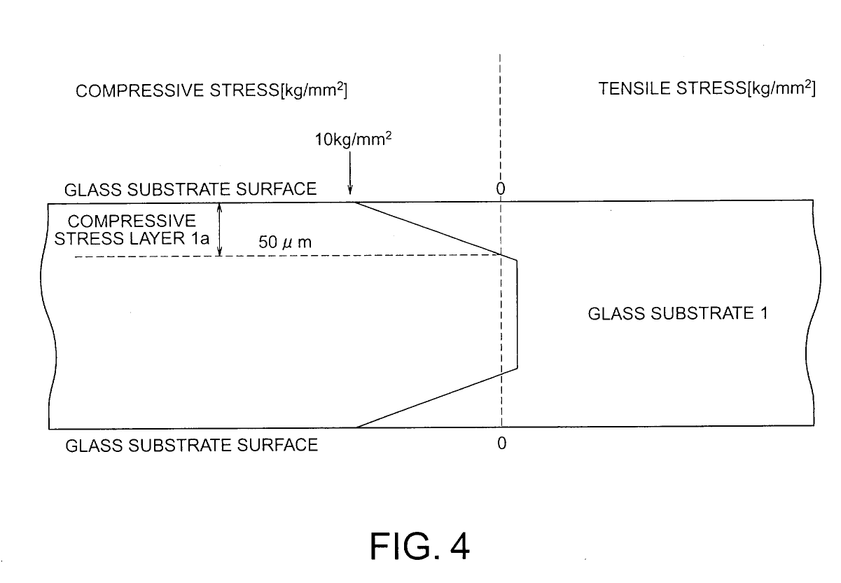

The glass substrate thus obtained was analyzed for a chemically strengthened layer as a surface layer by the use of a Babinet compensator. The result is shown in FIG. 4.

As a result, it was confirmed that the compressive stress layer la was formed as the surface layer of the glass substrate 1 by the chemically strengthening step.

The compressive stress value on the surface of the glass substrate was equal to 10 kg/mm². The compressive stress layer 1a had a thickness of 50 μm.

Next, measurement was made of a surface profile.

The surface profile was measured by the use of the AFM (Atomic Force Microscope). The measurement range was 5 μm×5 μm. As a result, the circumferential texture as the texture 100 was formed on the surface of the glass substrate. As surface characteristic values defined in Japanese Industrial Standard (JIS) B0601, Rmax and Ra were equal to 2.20 nm and 0.25 nm, respectively.

For the circumferential texture, Rmax is preferably not greater than 5.0 nm. With Rmax not greater than 5.0 nm, the touch down height can be reduced to 5 nm or less.

(9) Magnetic Disk Producing Step

By the use of a single-wafer sputtering apparatus, the seed layer 2, the underlying layer 3, the magnetic layer 4, and the protection layer 5 were successively formed on the glass substrate 1 provided with the texture 100 by sputtering using an Ar gas.

The seed layer 2 includes the first seed layer 2a comprising a Cr alloy thin film (having a thickness of 400 angstroms) and the second seed layer 2b comprising an AlRu thin film (having a thickness of 300 angstroms). The AlRu thin film has a composition of 50 at % Al and 50 at % Ru.

The underlying layer 3 comprises a CrW thin film (having a thickness of 100 angstroms) and serves to achieve an excellent crystal structure of the magnetic layer 4. The CrW thin film has a composition of 90 at % Cr and 10 at % W. In order to promote miniaturization of crystal grains, deposition was carried out in a mixed gas atmosphere containing an Ar gas and a CO₂ gas. The ratio of the CO₂ gas with respect to the Ar gas was equal to 0.75%. The magnetic layer 4 comprises a CoCrPtB alloy and has a thickness of 150 angstroms. The magnetic layer 4 has a composition of 62 at % Co, 20 at % Cr, 12 at % Pt, and 6 at % B. The distance from the glass substrate 1 to the magnetic layer 4 was equal to 800 angstroms because the first seed layer 2a, the second seed layer 2b, the underlying layer 3 had thicknesses of 400 angstroms, 300 angstroms, and 100 angstroms, respectively.

The protection layer 5 serves to prevent the magnetic layer 4 from being deteriorated by contact with a magnetic head. The protection layer 5 comprises a hydrogenated carbon film having a thickness of 50 angstroms and provides a wear resistance. By the use of a carbon target, the hydrogenated carbon film was deposited by sputtering in a mixed gas atmosphere containing an Ar gas and a hydrogen gas. The ratio of the hydrogen gas with respect to the Ar gas is 30%.

On a magnetic recording medium after the protection layer 5 was deposited, the lubrication layer 6 was formed in the following manner.

The lubrication layer 6 was formed by dipping the magnetic recording medium into a coating solution obtained by dissolving Fomblin Z-DOL manufactured by Ausimont, which is a perfluoropolyether liquid lubricant, in a Freon solvent (PF-5060 manufactured by 3M).

The lubrication layer 6 serves to buffer the contact between the magnetic recording medium and the magnetic head. The lubrication layer 6 has a thickness of 9 angstroms.

Next, the magnetic recording medium thus obtained was evaluated in the following manner.

Evaluation of Magnetic Characteristics

Magnetic characteristics were measured by VSM (Vibrating Sample Magnetometry). The magnetic recording medium was cut into a circular sample having a diameter of 8 mm. The sample was applied with an external magnetic field (±10 kOe) in each of a circumferential direction and a radial direction of the substrate to obtain a magnetization curve. From the magnetization curve, Mrt (product of residual magnetization and film thickness) was calculated.

The result is shown in Table 1. MrtOR was equal to 1.38. Thus, the magnetic recording medium excellent in circumferential anisotropy was obtained.

TABLE 1

| | Streng- | | | Thickness of | | Distance from | | | |
|---|---|---|---|---|---|---|---|---|---|
| | thening | Streng- | Compres- | Compressive | | Substrate | | | |
| | Tempera- | thening | sive | Stress | Circum- | Surface to | | | |
| | ture | Time | Stress | Layer | ferential | Magnetic Layer | Mrt(c) | Mrt(r) | MrtOR |
| | ° C. | min | kg/mm² | μm | Texture | angstrom | memu/cc | memu/cc | Mrt(c)/Mrt(r) |
| Examples | | | | | | | | | |
| 1 | 340 | 40 | 10 | 50 | formed | 800 | 0.301 | 0.218 | 1.38 |
| 2 | 340 | 40 | 10 | 50 | formed | 1000 | 0.287 | 0.217 | 1.32 |
| 3 | 340 | 40 | 10 | 50 | formed | 1200 | 0.285 | 0.231 | 1.23 |
| 4 | 330 | 15 | 3 | 5 | formed | 1000 | 0.280 | 0.229 | 1.22 |
| 5 | 330 | 30 | 8 | 10 | formed | 1000 | 0.285 | 0.219 | 1.30 |
| 6 | 340 | 100 | 12 | 80 | formed | 1000 | 0.297 | 0.220 | 1.35 |
| 7 | 380 | 180 | 17 | 100 | formed | 1000 | 0.297 | 0.219 | 1.36 |
| Comparative | | | | | | | | | |
| Examples | | | | | | | | | |
| 1 | 340 | 40 | 10 | 50 | formed | 1300 | 0.261 | 0.225 | 1.16 |
| 2 | 340 | 40 | 10 | 50 | not | 1000 | 0.257 | 0.258 | 1.00 |
| | | | | | formed | | | | |
| 3 | — | — | 0 | 0 | formed | 1000 | 0.258 | 0.228 | 1.13 |
| 4 | 310 | 10 | 2 | 3 | formed | 1000 | 0.260 | 0.228 | 1.14 |

Evaluation of Reliability

The magnetic recording medium was evaluated for glide characteristics. As a result, the touch down height was equal to 4.3 nm. Generally, the HDD required to have a recording density not lower than 40 Gbit/inch² must have a touch down height not higher than 5 nm.

The magnetic recording medium was subjected to a LUL durability test. As a result, the magnetic recording medium survived 600,000 consecutive times of LUL operations and no fault occurred. During the test, any trouble such as head crush or thermal asperity was not caused. In an environment where the HDD is generally used, about 10 years use is required before the number of times of LUL operations exceeds 600,000. In Example 1, the magnetic recording medium high in reliability and durability could be obtained.

### EXAMPLES 2 AND 3

Next, magnetic recording media in Examples 2 and 3 were produced.

In Example 2, the compressive stress value on the surface of the glass substrate and the total thickness of the nonmagnetic layers were selected to be equal to 10 kg/mm² and 1000 angstroms, respectively, so that MrtOR was equal to 1.32. In Example 3, the compressive stress value on the surface of the glass substrate and the total thickness of the nonmagnetic layers were selected to be equal to 10 kg/mm² and 1200 angstroms, respectively, so that MrtOR was equal to 1.23.

The magnetic recording medium in Example 2 was produced in the manner similar to Example 1 except that the first seed layer 2a, the second seed layer 2b, and the underlying layer 3 were formed to the thicknesses of 600 angstroms, 300 angstroms, and 100 angstroms, respectively, in the magnetic disk producing step. Thus, the distance from the surface of the glass substrate to the magnetic layer was equal to 1000 angstroms.

The result of evaluation of magnetic characteristics is shown in Table 1. MrtOR was equal to 1.32. In the glide test and the LUL durability test, no fault occurred like in Example 1.

The magnetic recording medium in Example 3 was produced in the manner similar to Example 1 except that the first seed layer 2a, the second seed layer 2b, and the underlying layer 3 were formed to the thicknesses of 600 angstroms, 400 angstroms, and 200 angstroms, respectively, in the magnetic disk producing step. Thus, the distance from the surface of the glass substrate to the magnetic layer was equal to 1200 angstroms.

The result of evaluation of magnetic characteristics is shown in Table 1. MrtOR was equal to 1.23. In the glide test and the LUL durability test, no fault occurred like in Example 1.

### COMPARATIVE EXAMPLE 1

Next, a magnetic recording medium in Comparative Example 1 was produced.

The magnetic recording medium in Comparative Example 1 was produced in the manner similar to Example 1 except that the first seed layer 2a, the second seed layer 2b, and the underlying layer 3 were formed to the thicknesses of 600 angstroms, 500 angstroms, and 200 angstroms, respectively. Thus, the distance from the surface of the glass substrate to the magnetic layer was equal to 1300 angstroms.

The result of evaluation of magnetic characteristics is shown in Table 1. MrtOR was equal to 1.16. In the glide text and the LUL durability test, no fault occurred like in Example 1.

Comparing the results of evaluation of the magnetic characteristics in Examples 1 to 3 and Comparative Example 1, it is understood that high circumferential anisotropy represented by MrtOR of 1.2 or more can be achieved in case where the distance from the surface of the substrate to the magnetic layer is not greater than 1200 angstroms. If the distance is not greater than 1000 angstroms, MrtOR of 1.3 or more is obtained. If the distance is not greater than 800 angstroms, MrtOR of 1.35 or more is obtained. Thus, the circumferential anisotropy is excellent.

### COMPARATIVE EXAMPLE 2

A magnetic recording medium in Comparative Example 2 was similar to the magnetic recording medium in Example 2 except that the texturing step was not carried out. The surface of the substrate in Comparative Example 2 was observed by an AFM. As a result, Rmax and Ra were equal to 2.10 nm and 0.21 nm, respectively. Since no texturing step was performed, no circumferential texture was observed. The result of evaluation of magnetic characteristics is shown in Table 1. MrtOR was equal to 1.00 and no anisotropy in the circumferential direction was observed. In the glide test and the LUL durability test, no fault occurred like in Example 2.

Comparing the results obtained in Example 2 and Comparative Example 2, it is understood that no anisotropy in the circumferential direction is obtained in case where the circumferential texture was not formed on the glass substrate.

### EXAMPLES 4-7

In Example 4, the compressive stress value on the surface of the glass substrate and the total thickness of the nonmagnetic layers were selected to be equal to 3 kg/mm² and 1000 angstroms, respectively, so that MrtOR was equal to 1.22.

The magnetic recording medium in Example 4 was obtained in the manner similar to Example 2 except that the chemically strengthening condition in the magnetic disk producing step was changed in order to achieve the predetermined compressive stress value.

Specifically, the chemically strengthening temperature was 330° C. and the chemically strengthening time was 15 minutes. Except these respects, the magnetic recording medium in Example 4 was similar to that in Example 2. The compressive stress value on the surface of the glass substrate, the thickness of the compressive stress layer, and the result of evaluation of magnetic characteristics are shown in Table 1. MrtOR was equal to 1.22. In the glide test and the LUL durability test, no fault occurred like in Example 2.

In Example 5, the compressive stress value on the surface of the glass substrate and the total thickness of the nonmagnetic layers were selected to be equal to 8 kg/mm² and 1000 angstroms, respectively, so that MrtOR was equal to 1.30.

The magnetic recording medium in Example 5 was obtained in the manner similar to Example 2 except that the chemically strengthening condition in the magnetic disk producing step was changed in order to achieve the predetermined compressive stress value. Specifically, the chemically strengthening temperature was 330° C. and the chemically strengthening time was 30 minutes. Except these respects, the magnetic recording medium in Example 5 is similar to that in Example 2. The compressive stress value on the surface of the glass substrate, the thickness of the compressive stress layer, and the result of evaluation of magnetic characteristics are shown in Table 1. MrtOR was equal to 1.30. In the glide test and the LUL durability test, no fault occurred like in Example 2.

In Example 6, the compressive stress value on the surface of the glass substrate and the total thickness of the nonmagnetic layers were selected to be equal to 12 kg/mm² and 1000 angstroms, respectively, so that MrtOR was equal to 1.35.

The magnetic recording medium in Example 6 was obtained in the manner similar to Example 2 except that the chemically strengthening condition in the magnetic disk producing step was changed in order to achieve the predetermined compressive stress value. Specifically, the chemically strengthening temperature was 340° C. and the chemically strengthening time was 100 minutes. Except these respects, the magnetic recording medium in Example 6 is similar to that in Example 2. The compressive stress value on the surface of the glass substrate, the thickness of the compressive stress layer, and the result of evaluation of magnetic characteristics are shown in Table 1. MrtOR was equal to 1.35. In the glide test and the LUL durability test, no fault occurred like in Example 2.

In Example 7, the compressive stress value on the surface of the glass substrate and the total thickness of the nonmagnetic layers were selected to be equal to 17 kg/mm² and 1000 angstroms, respectively, so that MrtOR was equal to 1.36.

The magnetic recording medium in Example 7 was obtained in the manner similar to Example 2 except that the chemically strengthening condition in the magnetic disk producing step was changed in order to achieve the predetermined compressive stress value. Specifically, the chemically strengthening temperature was 380° C. and the chemically strengthening time was 180 minutes. Except these respects, the magnetic recording medium in Example 7 is similar to that in Example 2. The compressive stress value on the surface of the glass substrate, the thickness of the compressive stress layer, and the result of evaluation of magnetic characteristics are shown in Table 1. MrtOR was equal to 1.36. In the glide test and the LUL durability test, no fault occurred like in Example 2.

### COMPARATIVE EXAMPLES 3 AND 4

A magnetic recording medium in Comparative Example 3 was similar to the magnetic recording medium in Example 1 except that the chemically strengthening step was not carried out. The result of evaluation of magnetic characteristics is shown in Table 1. Since no chemically strengthening step was performed, no compressive stress layer was formed on the surface of the glass substrate. As a result of evaluation of the magnetic characteristics, MrtOR was equal to 1.13. In the glide text, no fault occurred like in Example 1. In the LUL durability test, however, head crush was caused at 100,000 times of LUL operations and the magnetic recording medium was no longer operable.

A magnetic recording medium in Comparative Example 4 was obtained in the manner similar to Example 2 except that the chemically strengthening condition in the magnetic disk producing step was changed. Specifically, the chemically strengthening temperature was 310° C. and the chemically strengthening time was 10 minutes. Except these respects, the magnetic recording medium in Comparative Example 4 is similar to that in Example 2. The compressive stress value on the surface of the glass substrate, the thickness of the compressive stress layer, and the result of evaluation of magnetic characteristics are shown in Table 1. MrtOR was equal to 1.14. In the glide test and the LUL durability test, no fault occurred like in Example 2.

Comparing the test results in Examples 4 to 7, Example 2, and Comparative Examples 3 and 4, it is understood that high circumferential anisotropy represented by MrtOR of 1.2 or more can be achieved in case where the compressive stress value on the surface of the glass substrate is not smaller than 3 kg/mm². It is also understood that MrtOR of 1.30 or more can be achieved if the compressive stress value is not smaller than 8 kg/mm².

It is also understood that the magnetic recording medium having a predetermined oriented ratio of magnetic anisotropy can be produced by preliminarily obtaining the correlation between the oriented ratio and each of the compressive stress value on the surface of the glass substrate and the total thickness of the nonmagnetic layers, selecting the compressive stress value and the total thickness of the nonmagnetic layers as selected conditions with reference to the above-mentioned correlation, and forming the compressive stress layer of the glass substrate and the nonmagnetic layers in accordance with the selected conditions, as described in conjunction with Examples 1 to 7.

Although this invention is applied to the magnetic recording medium including the glass substrate in the foregoing description, this invention is also applicable to a magnetic recording medium including a substrate other than the glass substrate, for example, a metal substrate such as an aluminum alloy substrate or a metal coated substrate coated with a metal film such as NiP, with the texture formed on its surface. However, this invention is preferably applied to the magnetic recording medium using a glass substrate. In case of the glass substrate, high compressive stress can be produced on the surface of the substrate provided with the texture by the above-mentioned ion exchange or crystallization. In addition, the compressive stress is uniform within a plane. The compressive stress value and the thickness of the compressive stress layer can be designed with a high degree of freedom.

According to this invention, it is possible to provide a magnetic recording medium having MrtOR of 1.2 or more, excellent in shock resistance, and low in production cost.

It is also possible to provide a method of producing a magnetic recording medium having MrtOR of a desired value with excellent reproducibility and at a low cost.

What is claimed is:

1. A magnetic recording medium comprising: a glass substrate which has a principal surface and which includes a compressive stress layer as a surface layer having said principal surface; and a magnetic layer formed on the principal surface of said the glass substrate; wherein:
compressive stress produced on the principal surface of said glass substrate is equal to 3 kg/mm² or more;
said glass substrate having the principal surface provided with a texture for inducing magnetic anisotropy in said magnetic layer;
a distance from the principal surface of said glass substrate to the magnetic layer being equal to 1200 angstroms or less.

2. A magnetic recording medium as claimed in claim 1, wherein a nonmagnetic layer interposed between the principal surface of said glass substrate and the magnetic layer has a thickness not greater than 1200 angstroms.

3. A magnetic recording medium as claimed in claim 1 or 2, wherein the compressive stress layer has a thickness not smaller than 5 μm.

4. A magnetic recording medium as claimed in any one of claims 1 through 3, wherein an oriented ratio of magnetic anisotropy in terms of a product of residual magnetization and film thickness is not smaller than 1.2 in said magnetic recording medium.

5. A magnetic recording medium as claimed in any one of claims 1 through 4, wherein:
said compressive stress layer is formed by ion exchange.

6. A magnetic recording medium as claimed in any one of claims 1 through 5, wherein:
said magnetic layer has a hcp crystal structure.

7. A magnetic recording medium comprising: a glass substrate which has a principal surface and which includes a compressive stress layer as a surface layer having said principal surface; and a magnetic layer formed on the principal surface of said the glass substrate; wherein:
said glass substrate has the principal surface provided with a texture for inducing magnetic anisotropy in said magnetic layer;
an oriented ratio of magnetic anisotropy in terms of a product of residual magnetization and film thickness being equal to 1.2 or more in said magnetic recording medium.

8. A method of producing a magnetic recording medium having magnetic anisotropy, in which a nonmagnetic layer and a magnetic layer are formed on a principal surface of a glass substrate having a compressive stress layer as a surface layer and a texture formed on said principal surface of the glass substrate to induce magnetic anisotropy in said magnetic layer, said method comprising the steps of:
preliminarily obtaining correlation between an oriented ratio of magnetic anisotropy and each of a compressive stress value on the principal surface of said glass substrate and a thickness of said nonmagnetic layer;
selecting the compressive stress value and the thickness of said nonmagnetic layer as selected conditions with reference to the correlation so as to obtain a predetermined oriented ratio; and
forming the compressive stress layer of said glass substrate and said nonmagnetic layer in accordance with the selected conditions.
